(19) United States
(12) Patent Application Publication
(10) Pub. No.: US 2013/0091228 A1
(43) Pub. Date: Apr. 11, 2013

(54) NOTIFICATION SYSTEM

(71) Applicants: Ying DU, Kanata (CA); Ronald RICHARDSON, Kanata (CA)

(72) Inventors: Ying DU, Kanata (CA); Ronald RICHARDSON, Kanata (CA)

(73) Assignee: BENBRIA CORPORATION, Ottawa (CA)

(21) Appl. No.: 13/268,141

(22) Filed: Oct. 7, 2011

(51) Int. Cl. G06F 15/16

(52) U.S. Cl. 709/206

(57) ABSTRACT

A server and methods relating to a notification system having a client request gateway for validating client requests and for mapping client requests with transactions. The notification system also has an enterprise interaction engine for receiving the transactions and mapping transactions with interactions. These interactions are sent to applications servers that produce interactions results. Interaction results are then associated with transactions results. Based on the transaction results, notifications are created and sent to members of an audience.

### TECHNICAL FIELD

The specification relates generally to notification, and specifically to methods, apparatus, and systems for providing notifications to an audience after a client request has been received.

### BACKGROUND OF THE INVENTION

Traditionally, notification systems were loosely integrated into enterprise Information Technology (IT) architectures. In fact, several notification systems may exist. Email notification was likely integrated into business processes to generate awareness of ongoing events. Audio notification was integrated into emergency services and security. These were generally completely separate systems.

With the advent of Service Oriented Architectures in enterprise IT architecture, a new network element is possible to integrate notification systems into enterprise process. This allows for:

1. The automation of end-to-end communication within the enterprise and between the enterprise and its external customers ensuring key stakeholders are aware of current business events

2. Improved customer service ensuring that significant events are handled in a timely manner

3. Enable automatic enterprise processes initiated by the customer

4. Improved operational efficiency as a result of the automated processes.

A key aspect is the integration of new enterprise communication functions such as Short Message Service (SMS) as part of the end-to-end communication.

### SUMMARY OF INVENTION

The present invention provides a server and methods relating to a notification system having a client request gateway for validating client requests and for mapping client requests with transactions. The notification system also has an enterprise interaction engine for receiving the transactions and mapping transactions with interactions. These interactions are sent to applications servers that produce interactions results. Interaction results are then associated with transactions results. Based on the transaction results, notifications are created and sent to members of an audience.

In a first aspect, the present invention provides a server for use in an enterprise as a notification server, the server comprising:

a client request gateway module for receiving and validating client requests, said client request gateway also being for mapping validated client requests with transactions;

an enterprise interaction engine module for receiving said transactions from said client request gateway and for producing transactional results, said transactional results being based on results of interactions, said interactions being translated from said transactions, said interactions being processed by external application servers;

a notification engine module for creating notifications for transmittal to an audience, said notifications being based on said transactional results;

wherein

said transactions are for coordinating activities relating to a specific client request;

said interactions are activities related to a specific client request, said activities being for execution by an external application server;

said notifications being at least one message for communication to at least one member of said audience;

said client requests originate as text messages from client devices.

In a second aspect, the present invention provides a method for processing incoming communication client requests, the method comprising:
a) receiving an incoming client request, said incoming client request being derived from a text message from a client device;
b) validating said incoming client request;
c) creating at least one transaction associated with said incoming client request;
d) creating at least one interaction relating to said at least one transaction;
e) transmitting said at least one interaction to at least one application server for execution;
f) receiving at least one interaction result from said at least one application server;
g) creating at least one transaction result based on said at least one interaction result;
h) transmitting at least one notification to members of an audience, said at least one notification being based on said at least one transaction result;

wherein

said transactions are for coordinating activities relating to a specific client request;

said interactions are activities related to a specific client request, said activities being for execution by an external application server; and

said notifications being at least one message for communication to at least one member of said audience.

### BRIEF DESCRIPTION OF THE DRAWINGS

Embodiments of the present invention will now be described, by way of example only, with reference to the attached Figures, wherein:

FIG. 1 is a network diagram describing the network elements which interact with an Intelligent Enterprise Notification Server;

FIG. 2 illustrates a communication cycle as handled by an Intelligent Enterprise Notification Server;

FIG. 3 breaks down the composition of a notification;

FIG. 4 breaks down the Intelligent Enterprise Notification Server shown in FIG. 1;

FIG. 5 is a flowchart showing how the Client Request Gateway handles requests from a Client Device;

FIG. 6 is a flowchart showing how the Enterprise Interaction Engine handles Transactions;

FIG. 7 is a flowchart showing how the Notification Engine handles a Notification;

FIG. 8 provides examples of client management options.

FIG. 9 provides examples of transaction management options;

FIG. 10 provides examples of notification management options;

FIG. 11 shows an example of an IENS communication cycle which can be prompted by SMS to retrieve information for clients;

FIG. 12 shows an example of an IENS communication cycle which can store business intelligence gathered via SMS;

FIG. 13 shows an example of an IENS communication cycle where a peer Enterprise Application Server generates a notification;

FIG. 14 shows an example of an IENS communication cycle where a customer registers for a membership related to an enterprise;

FIG. 15 shows an example of an IENS communication cycle where the enterprise communicates with its members using SMS;

FIG. 16 shows the logic of a smartphone application which rates the service of an enterprise;

FIG. 17 shows the communication cycle created by the smartphone application once the rating has been sent; and

FIG. 18 shows an example of an IENS communication cycle where the enterprise requests from its employees to select from a choice of options.

### DETAILED DESCRIPTION OF THE INVENTION

Enterprise service offerings are expanding to not only encompass new customer interaction mechanisms, such as mobile Short Message Service (SMS) and smartphone applications, but to also integrate into social media mechanisms, such as Facebook and Twitter for the public and SharePoint for enterprise. These new mechanism need to be integrated with legacy enterprise systems to allow for a seamless evolution of services while ensuring that current capital investments of the enterprise are leveraged to their full potential.

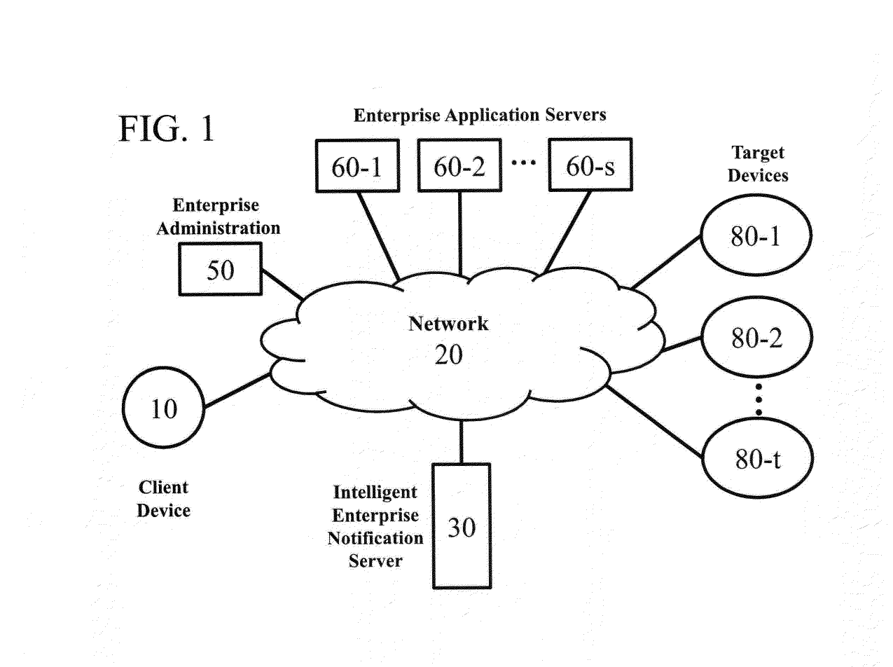

One way to integrate these new mechanisms into enterprise serviced offerings is to deploy an Intelligent Enterprise Notification Server (IENS). An IENS sits between enterprise clients, enterprise application servers, and enterprise communication mechanisms to coordinate activity between these network elements to achieve a business function (or functions). An example of a network where the IENS element operates is illustrated in FIG. 1. An IENS is deployed as network element 30 in the centre of the network. The IENS 30 interfaces with the Network 20 to interface with the Client Device 10. The Client Device 10 represents any entity which can signal the IENS 30 to perform an enterprise function. The Client Device 10 can be a cell phone using SMS, a smartphone using an application or browser-based application, a traditional telephone using regular calling, or an internal or external computer using a machine interface such as Hypertext Transfer Protocol (HTTP), Session Initiation Protocol (SIP), Simple Object Access Protocol (SOAP) or a similar mechanism.

It should be noted that no specific attributes are assumed regarding the Network 20. The network 20 provides connectivity between the Client Devices 10 and the IENS 30 such that reasonable communication between the Client Devices 10 and the IENS 30 is supported. Once the IENS 30 receives a client request, originating from a client device, the IENS 30 ensures that the request is valid. The IENS 30 then interacts with peer Enterprise Application Servers 60 through the Network 20 to complete the request. The business logic of how the request is handled can be resident on the IENS 30 and/or the Enterprise Application Server 60. This logic is programmed into the IENS 30 and the Enterprise Application Server 60 through the Enterprise Administration Server 50. Once the request is complete, the result is returned to the IENS 30. This can result in two activities—a response to the client device and a notification to a target device. The response to the client device is provided if required. The client request can also generate a notification to the Target Devices 80 through the Network 20. A notification is one or more sets of messages which need to be communicated to a target audience based upon the result of the client request. How the result is handled is identified by the policy set by the Enterprise Administration Server 50. Following notification to the Target Devices 80 through the Network 20, client acknowledgements or other responses may be received by the IENS through the Network 20.

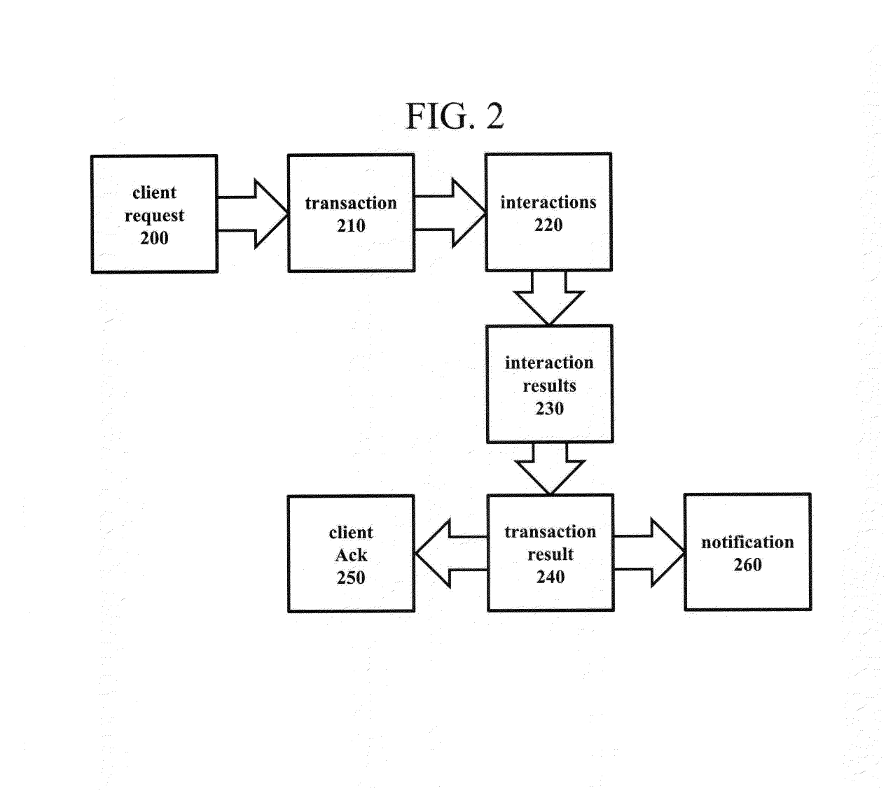

To handle a request from a Client Device 10, the IENS 30 creates a communication cycle. This cycle is described with reference to FIG. 2. Once a client request 200 is received, the IENS 30 creates a transaction 210 to coordinate all activities related to this client request 200. A transaction 210 creates interactions 220 which are activities related to the current client request 200 that need to be executed by peer Enterprise Servers 60. Interactions can include:
1. Validation of the client request by a policy server. Such interactions can, for example, be handled by using protocols such as Remote Authentication Dial In User Service (RADIUS), DIAMETER or Terminal Access Controller Access-Control System (TACACS);
2. Retrieval or storage of information using database servers. In one example, these interactions can be completed using Structured Query Language (SQL);
3. Service Oriented Architecture requests using a Web Services Description Language (WSDL), SOAP, or the Common Alerting Protocol (CAP);
4. Reporting of transactions to a supervisory business system such as Business Intelligence (BI) or Customer Relationship Management (CRM) systems.

Many other interactions are possible given the flexibility of the enterprise Information Technology (IT) infrastructure. Once the interactions 220 are complete, the IENS 30 determines the transaction result 240 using the interaction results 230. The closing of the transaction can include a client acknowledgement 250 and/or a notification 260 to Target Devices 80.

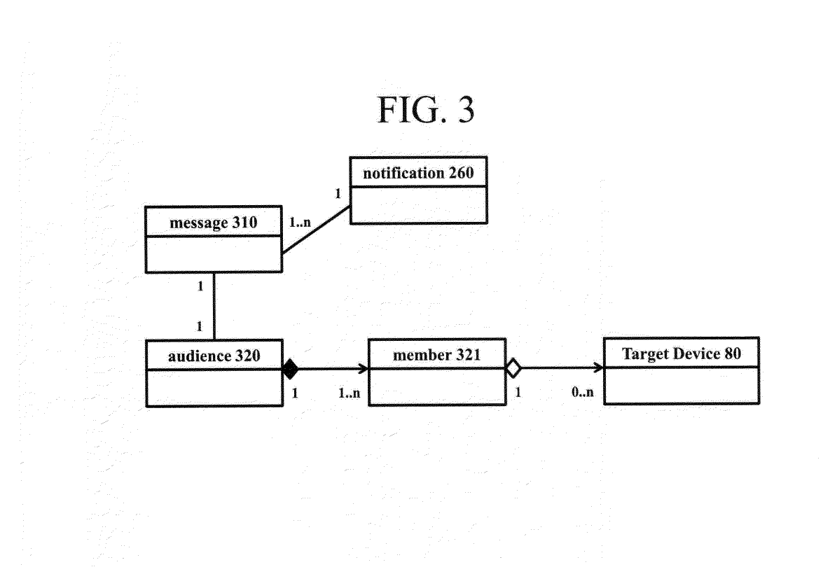

A notification 260 is an abstraction of communication required based upon the transaction result 240. With reference to FIG. 3, a definition of a notification 260 can be provided. It is a set of messages 310 which needs to be communicated to an audience 320. A message 310 can be an email, a voice message, a text message, a machine to machine (M2M) message or other forms of communication. The audience 320 is a set of members 321, each of whom who has at least one Target Device 80. To further explain by example, an email message can be the message 310 with an audience 320 embodied by the “TO: list, the “CC” list and the “BCC” list. Each list is populated with the email addresses of the audience members 321, the email addressed being the Target Devices 80 in this case. In the case where the message 310 is an SMS text message, each member 321 of the audience 320 has at least one cell phone number which represents the target device 80.

An enterprise can integrate communication cycles into their business processes in many ways. They can be used to communicate with internal and external stakeholders as the business process may require. As such, a single iteration of a business process can involve one or more communication cycles provided by the IENS 30, as may be required by the enterprise. Examples of communication cycles are included later in this document.

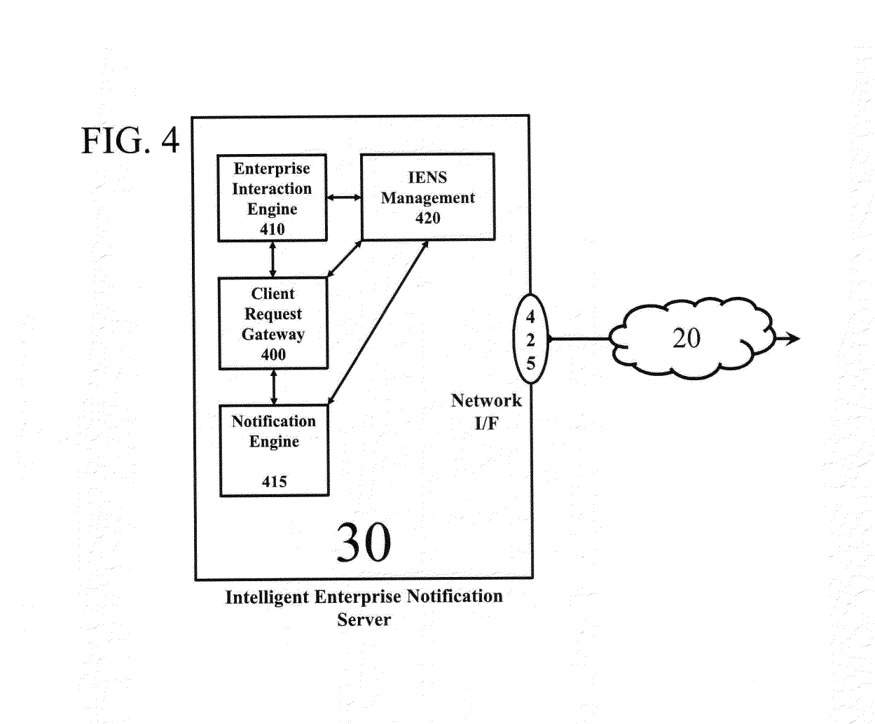

A functional description of an embodiment describing how the IENS 30 handles a client request 200 is provided with reference to FIG. 4. Interactions with Client Devices 10 are controlled through the Network Interface 425. This interface queues the client requests 200 as they are received and passes these to the Client Request Gateway 400. The Gateway 400 is responsible for translating the client request 200 into a transaction 210 to be handled by the Enterprise Interaction Engine 410. When the Engine 410 receives a transaction 210, the Engine 410 translates the transaction 210 into a set of interactions 220 and queues these for processing. Interactions 220 use the Network Interface 425 to communicate with peer Enterprise Application Servers 60. Once all the interactions 220 are complete the interaction results 240 are received and the Enterprise Interaction Engine 410 produces a transaction result 240 based upon these interaction results 230. The transaction result 240 is then passed to the Client Request Gateway 400 for processing. Based upon the transaction result 240, the Client Request Gateway 400 creates a client acknowledgement 250 and a notification 260. The client acknowledgement 250 is passed back to the Client Device 10 through the Network Interface 425. This closes the transaction from the client's perspective. The notification 260 is passed to the Notification Engine 415 to create the messages 310 to communicate the results to other interested parties identified as the Audiences 320. The messages 310 are communicated to the Target Devices 80 through the Network Interface 425. How these transactions 210 are handled is managed by the IENS Management Function 420. It interacts with the other functional blocks to control their behavior and operation. More details on these functional blocks are provided below.

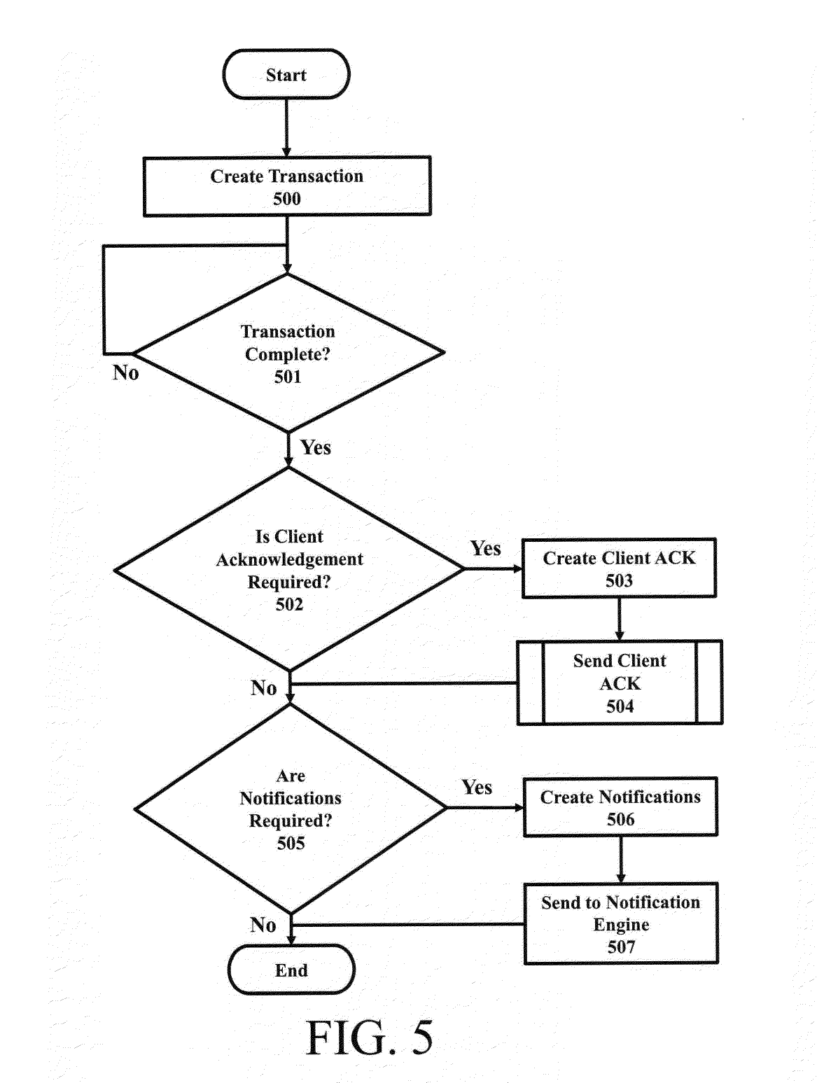

FIG. 5 is a flowchart detailing the steps involved when a Client Request Gateway 400 handles a client request 200. The first step is to map the client request 200 into a transaction 210 (Step 500). This transaction 210 is passed to the Enterprise Interaction Engine 410 and the Client Request Gateway 400 waits for a transaction result 240 (Step 501). When the transaction result 240 arrives, the Client Request Gateway 400 checks to see if a client acknowledgement 250 is required (Step 502). If so, the response is formatted (503) and sent to the Client Device 10 (Step 504). Note that Step 504 is a procedure since the exact mechanism of the client acknowledgement 250 depends on the Client Device 10. Then the Client Request Gateway 400 checks to see if notifications 260 are required (Step 505). If so, the Notifications 250 are formatted (Step 506) and passed to the Notification Engine 415 (Step 507).

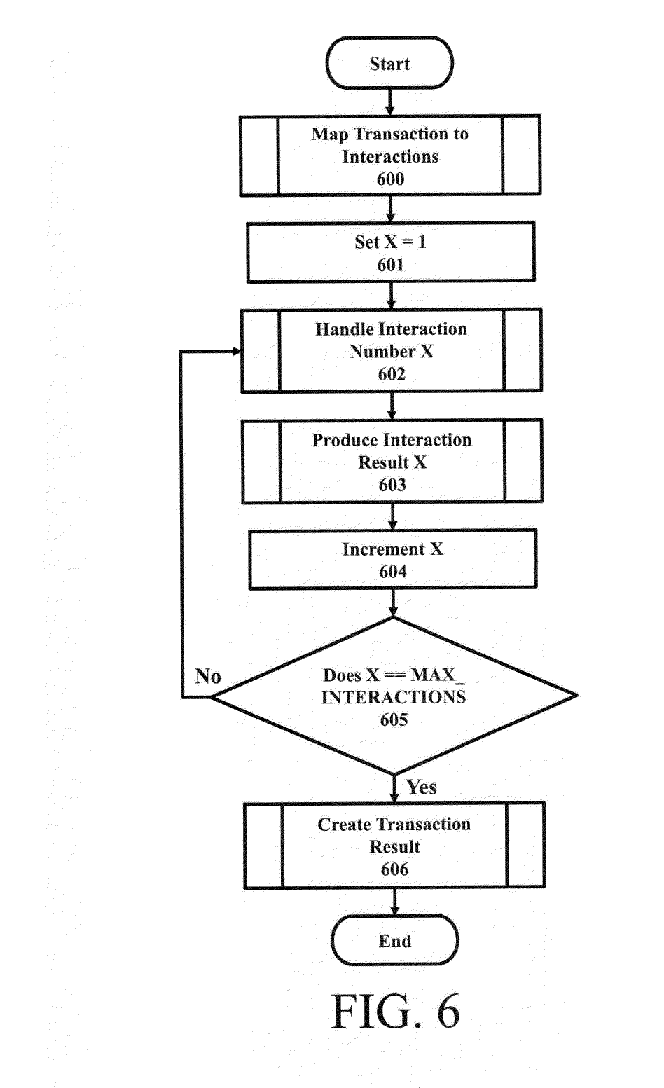

FIG. 6 illustrates the steps involved when the Enterprise Interaction Engine 410 handles a transaction 210. The first step is to create the interactions 220 which are required to complete the transaction 210 (Step 600). Then, for each interaction 220, the Enterprise Interaction Engine 410 iterates through each interaction 220 until all the interactions are complete (Step 601 to Step 605). The interaction results from this process are then received and, based upon these interaction results 230, a transaction result 240 is generated (Step 606). The transaction result 240 is then returned to the Client Request Gateway 400.

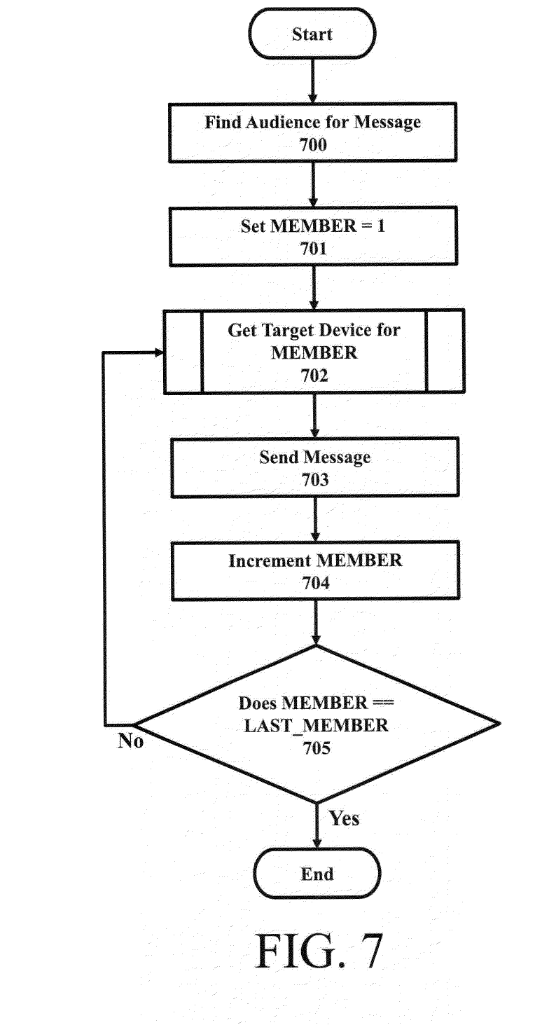

The flowchart of FIG. 7 details the steps as to how the Notification Engine 415 handles a message 310 for a notification 260. The first step is to identify the audience 320 (Step 700). Then, for each audience member 321, the Target Device 80 is identified (Step 702) and the message 310 is sent to the Target Device (Step 703). This process is repeated for each audience member 321 until the last member is reached (Step 703 and Step 704).

Given the flexibility of the functionality provided by the IENS, the IENS Management 420 requires a comprehensive user interface to cover all the functions provided within the server. Preferably, before the IENS can be integrated into a business function or a business process, the components (i.e. Client Devices 10, Transaction 210, and notifications 260) are defined or provided for in the system. Once a set of these components are provisioned for in the system, these components can be assembled into communication cycles which can be integrated into business processes. Note that the components can be re-used across communication cycles. For example, the same Client Device 10 could generate different Transactions 210 and the results of a Transaction 210 could generate different Notifications 260.

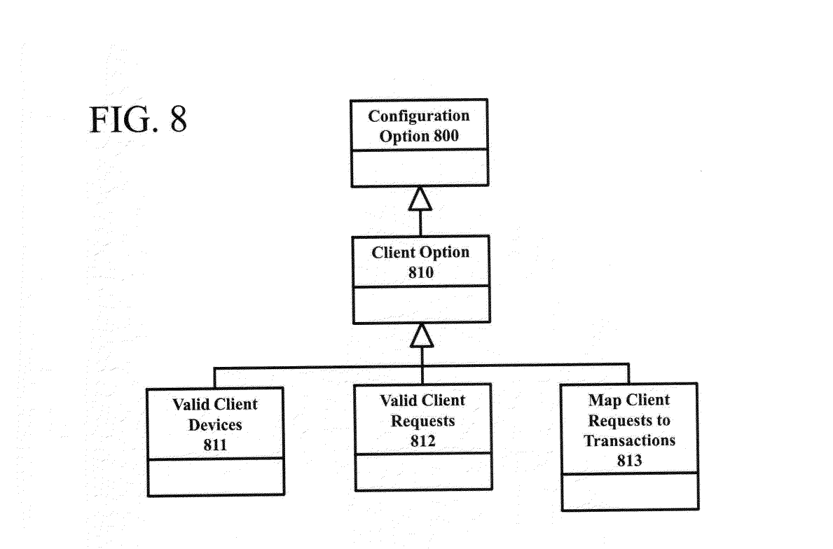

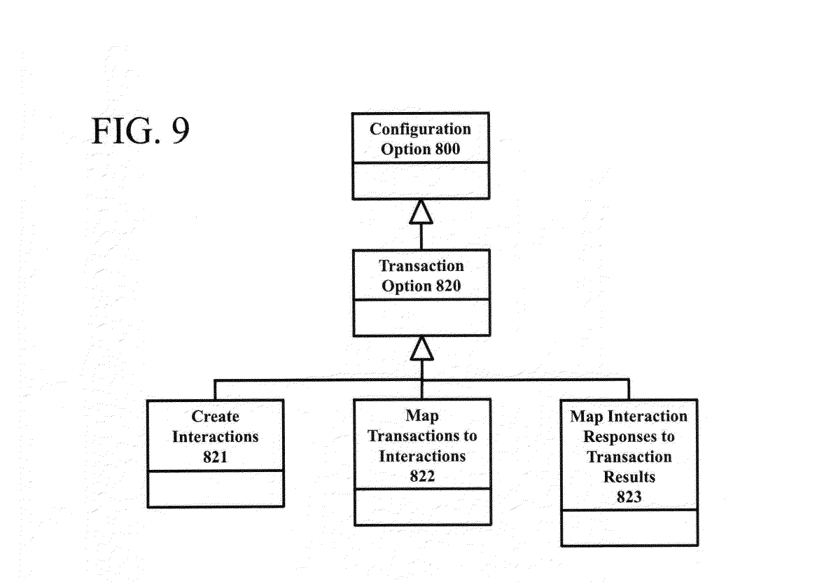

FIGS. 8-10 illustrates some of the configuration options (800) available in an IENS. The figures detail user interface trees which show options available to an administrator of the IENS. In FIG. 8, from configuration options 800, an administrator may access the Client options (810). From this menu, the options may include: managing the Client Devices 10 which can access the IENS (managing the validity of client devices 811), managing the valid client request 200 which can be created by these devices (812), and mapping the valid Client Request 200 to Transactions 210 (813). FIG. 9 provides examples of management options for the user interface. The administrator for the IENS starts with the configuration options 800 and, from this, transaction options 820 may be selected. From this option, the administrator may manage interactions created by the relevant transactions 210 (821). The administrator may also manage the mapping of Transactions 210 to interactions 220 (822). The mapping of the interaction responses to the transaction results may also be managed by the administrator (823).

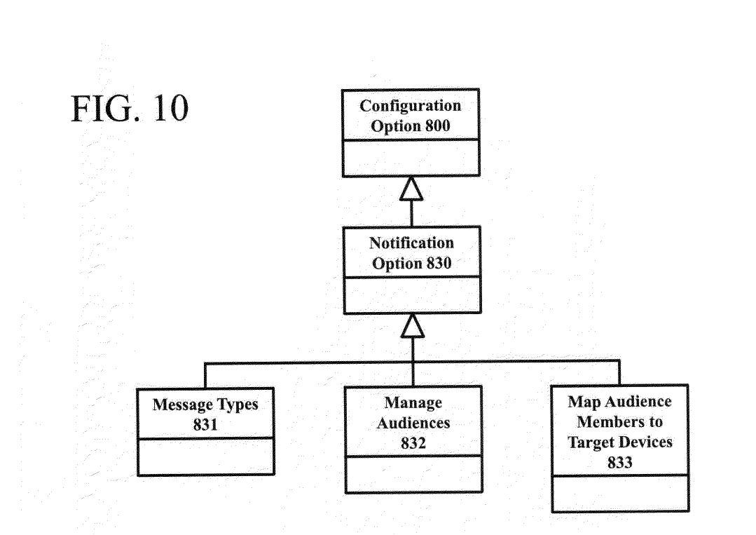

Referring to FIG. 10, the administrator may also manage notification options from the configuration options. From Configuration Options 800, the administrator may select Notification Options 830. The types of messages 310 can be managed and defined (831). As well, Audiences 320 can also be managed from this set of user interfaces (832). The mapping of the audience members 321 to their target devices 80 can be managed using user interface 833.

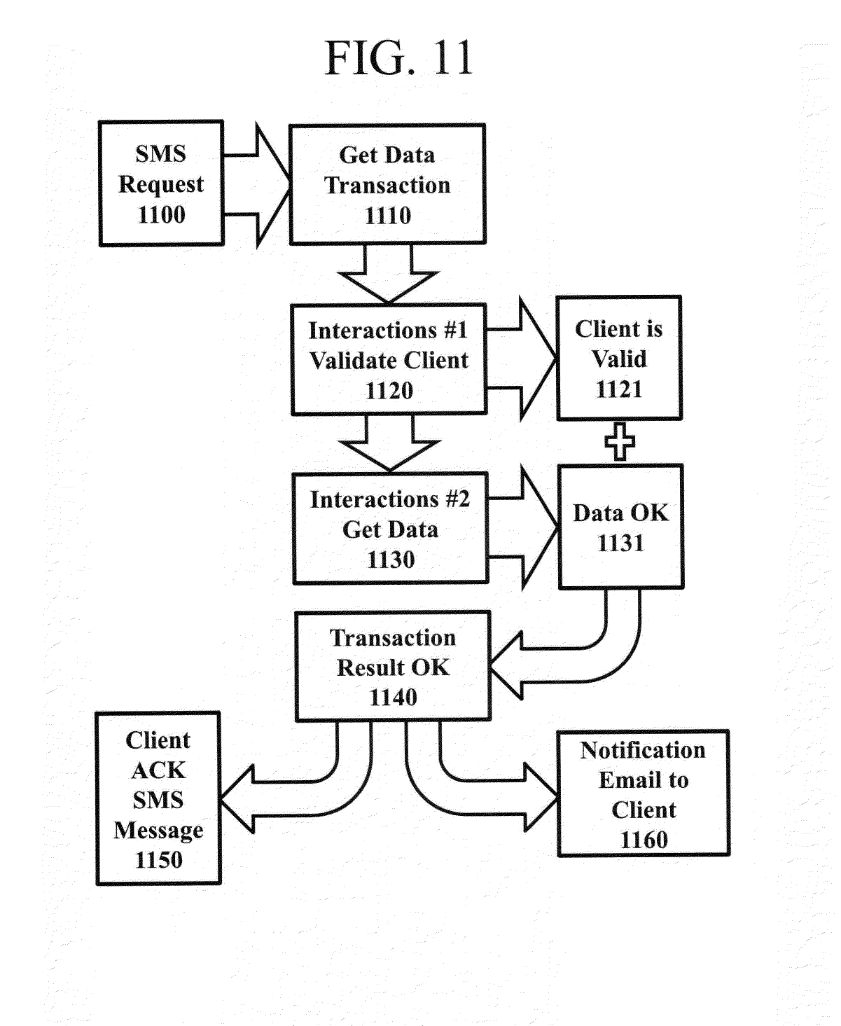

Many possible options exist to integrate an IENS into Enterprise operations. Examples of the use of an IENS 30 are provided below. The first example is provided with reference to FIG. 11. For this example, the IENS 30 is deployed to handle customer data requests via SMS. In this example, data is requested by the client by way of SMS and the data is returned to the client's target device. When the SMS request is received (1100), the client is identified and the contents of the request are analyzed, leading to the creation of a Get Data Transaction (1110) operation. This Get Data transaction is converted into two interactions: the validation of the client (1120) and the retrieval of the information requested by the client (1130). When both of these interactions succeed, a positive Transaction Result is created (1140). Based on this transaction result, a notification (for this example, the notification is an SMS message or messages) providing this information (1150) is returned to the client. For this example, the client is notified on a second target device—the client is notified using the same transaction result using the client's email (1160). This second notification may contain more detailed information than the notification sent to the client's mobile telephone. The above described mechanism may be used by clients to retrieve data from the enterprise's databases. As an example, an enterprise customer could use this mechanism to retrieve warrantee information related to their specific product purchased from the enterprise.

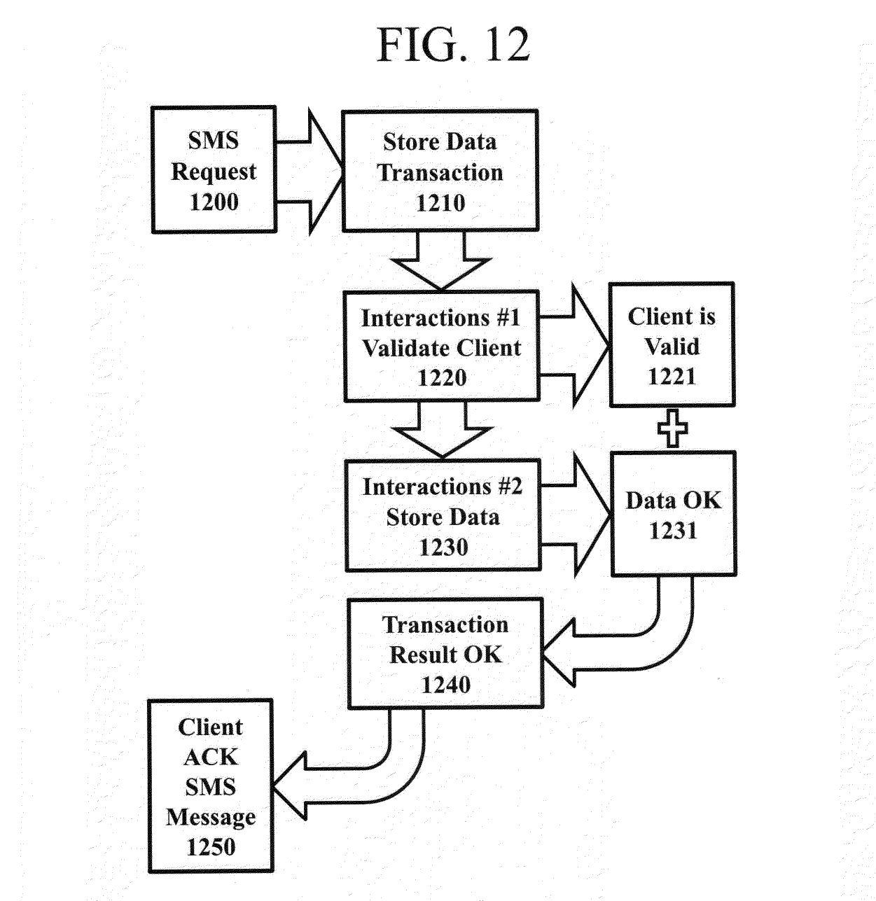

Another example, shown in the flowchart of FIG. 12, details the steps when using SMS to gather business intelligence. A client request is received (1200) to create a transaction to store data (1210). This transaction generates two interactions: the first interaction validates that the client can store data (1220) and the second interaction stores the data on the external application server (1230). When both interactions are successful, a successful transaction result is generated (1240). Based on this, a client acknowledgement is generated and an SMS message is sent back to the client (1250).

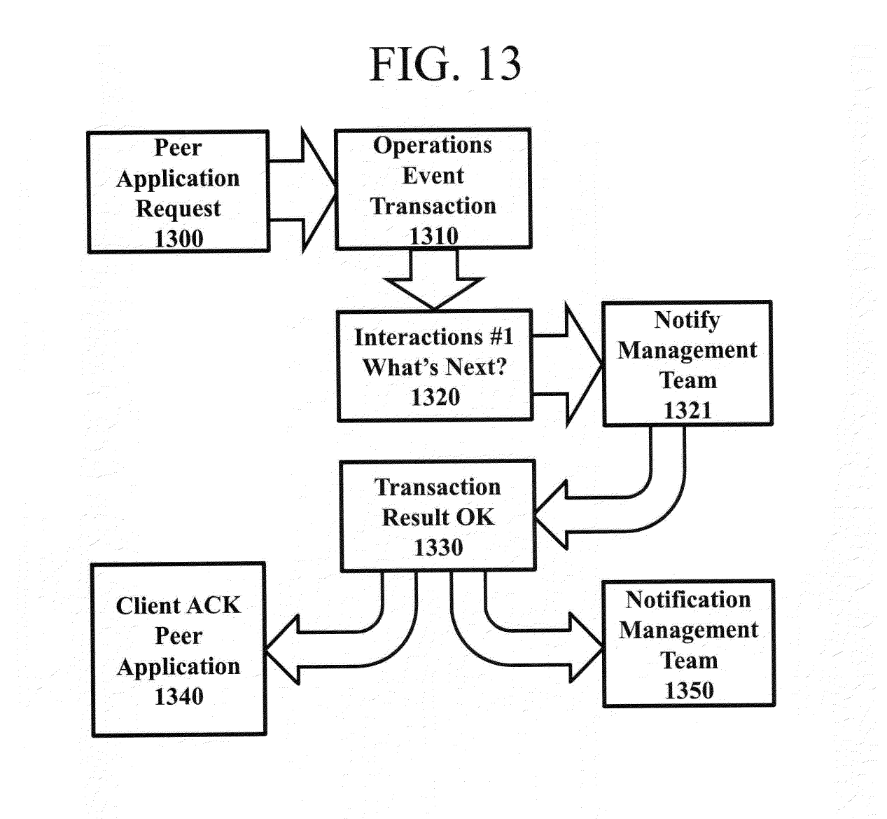

Referring to FIG. 13, another example of a use of the invention is detailed. For this example, a peer application is the source of the client request. The process begins with the peer Enterprise application server creating a client request to notify peer servers of an event (1300). The transaction created for this event (1310) queries an external policy server what function to perform next (1320). The response directs the IENS to notify the management team of the event (1321). Based on the transaction result, a notification is created with the audience set to the management team (1330). The notification is then sent to the management team (1350) and an acknowledgement that the request has been handled is also sent to the originating peer application (1340).

IENS 30 can implement a combination of these communication cycles described above. For example, the embodiment in FIG. 12 can be combined with FIG. 13 to escalate enterprise events to management based upon business intelligence gathered over SMS. For example, the SMS events generated in FIG. 12 could document issues with the operations of the enterprise. This data can be analyzed by a peer Enterprise Application Server 60 and assigned an urgency which requires management attention. If necessary, the peer Enterprise Application Server 60 can escalate the issue using the communication cycle described in FIG. 13.

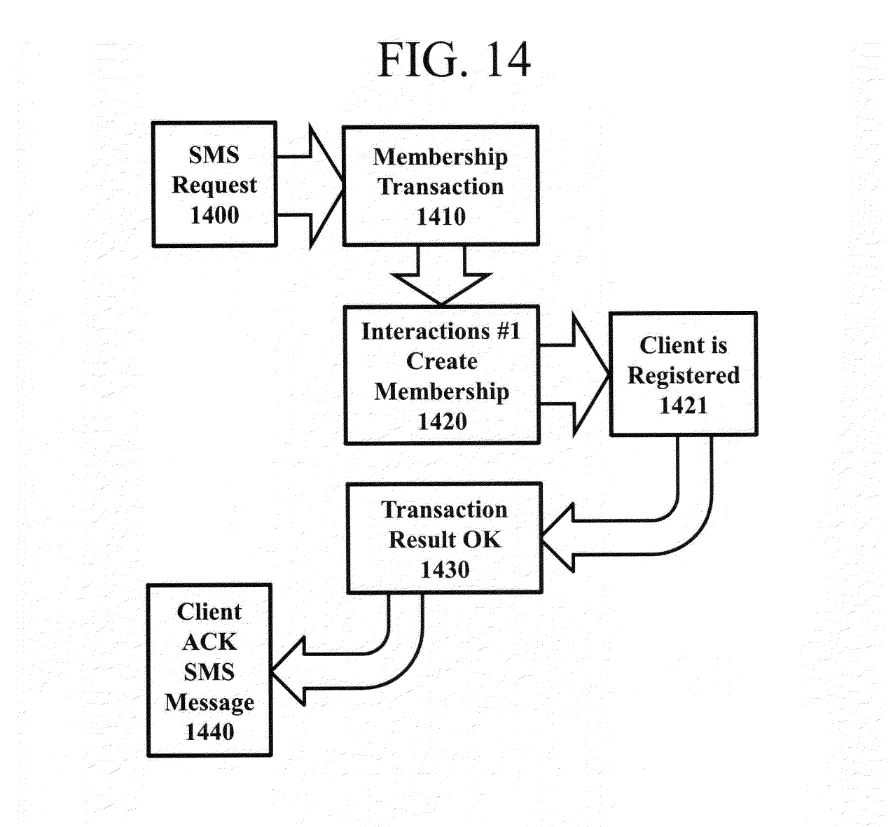

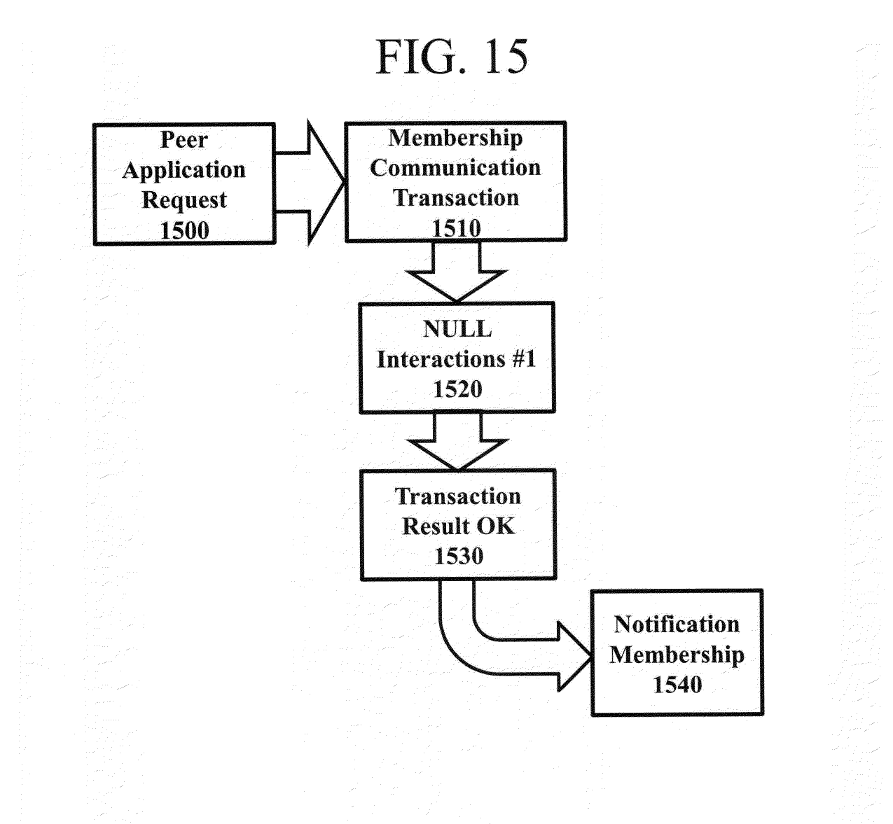

FIGS. 14 and 15 present another example of a business process which incorporates two communication cycles. This business process allows customers of an enterprise to register for a group membership using SMS on a mobile device. The enterprise can communicate with the group to keep them informed on relevant information which interests the group such as upcoming sales or discounts on particular products of interest. FIG. 14 summarizes the steps in a communication cycle for a client registering with the group. An SMS is received requesting membership (1400) which initiates a transaction (1410). This creates an interaction with the enterprise server handling group registration with the interaction causing the server to add the client device (1420). After this transaction succeeds (1421 and 1430), an SMS indicating that the transaction has succeeded is sent to the client (1440).

The flowchart in FIG. 15 details the steps involved when the enterprise uses the group membership to communicate with the group members. In this embodiment, a peer enterprise server makes a request (1500) to initiate a communication transaction (1510). Since all the information required was provided in the request (1500), the IENS creates a NULL transaction (1520) which automatically generates a positive transaction result (1530). Based upon this, a notification (1540) is created to communicate to the audience group which is mapped to the notification audience. In this example, parts of the configuration interface to the IENS can be exposed to the customer who receives the notification. This way, the customer can augment the attributes of his/her Client Device 10, his/her Audience Member attributes, and the groups which they are a member of.

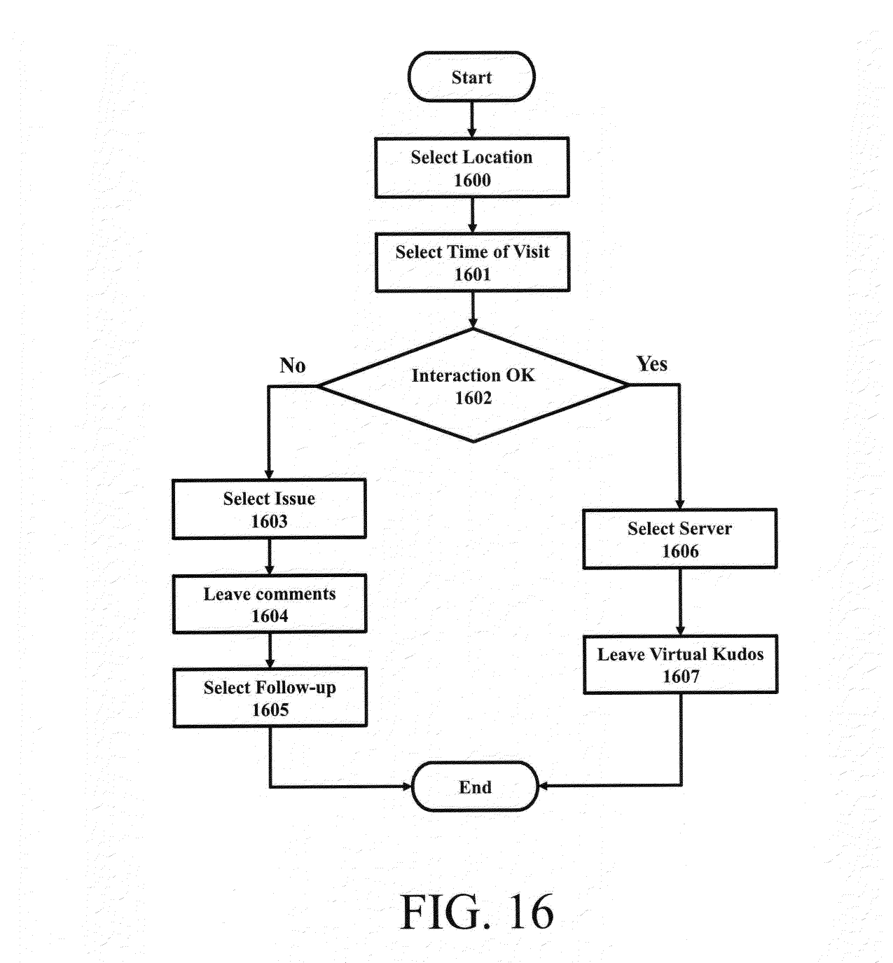

In another embodiment of the invention, the IENS interacts with a smartphone application which is used to rate an enterprise's performance with a particular customer. This embodiment can be deployed for franchise restaurants to rate the latest experience of a customer. If there are issues, the manager of the particular enterprise location can maintain contact with the customer while the issue is being addressed. FIG. 16 shows the logic of the smartphone application in creating a client request for the IENS. When a rating is initiated, the customer selects the location (1600) and the time of the encounter with the location (1601). Then, depending on the nature of the encounter, the customer needs to add different information (1602). If the encounter was positive, the customer can identify the person(s) who dealt with them during their recent visit (1606) and leave positive feedback for this person (1607). If the experience was negative, the customer can identify the issue with their recent experience (1603) and leave more detailed comments describing the issue and course of action for resolution (1604). They can also identify whether they are interested in receiving updated information related to the issue (1605).

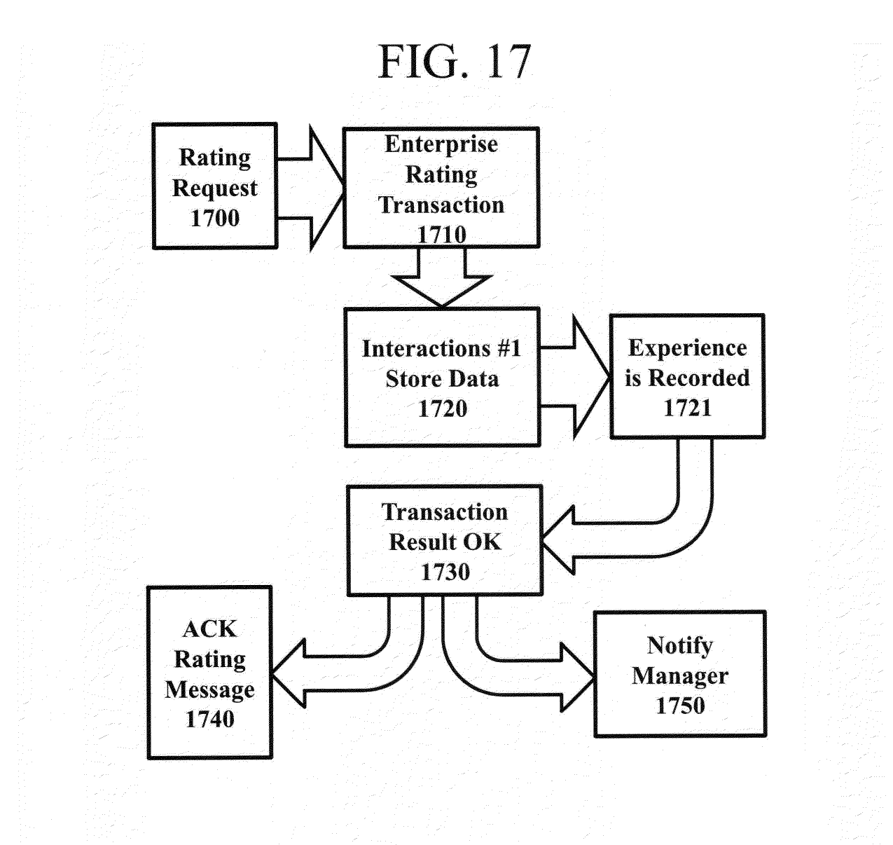

Once the smartphone application has completed collecting the information, it is sent to the enterprise's IENS 30, thereby initiating a communication cycle. The steps in this cycle are described with reference to FIG. 17. When the rating is received by the IENS 30 (1700), IENS 30 creates a transaction to handle the rating information (1710). This creates an interaction with a peer enterprise server to record the experience (1720). If, as in this case, the experience was negative, two messages are created as part of the notification. The customer is notified that their issue has been logged with the enterprise (1740) and the manager of the particular enterprise location is informed (1750). As the manager addresses the issue, the customer can remain informed. Such an implementation and use of the invention can also use communication cycles similar to those illustrated in FIG. 15.

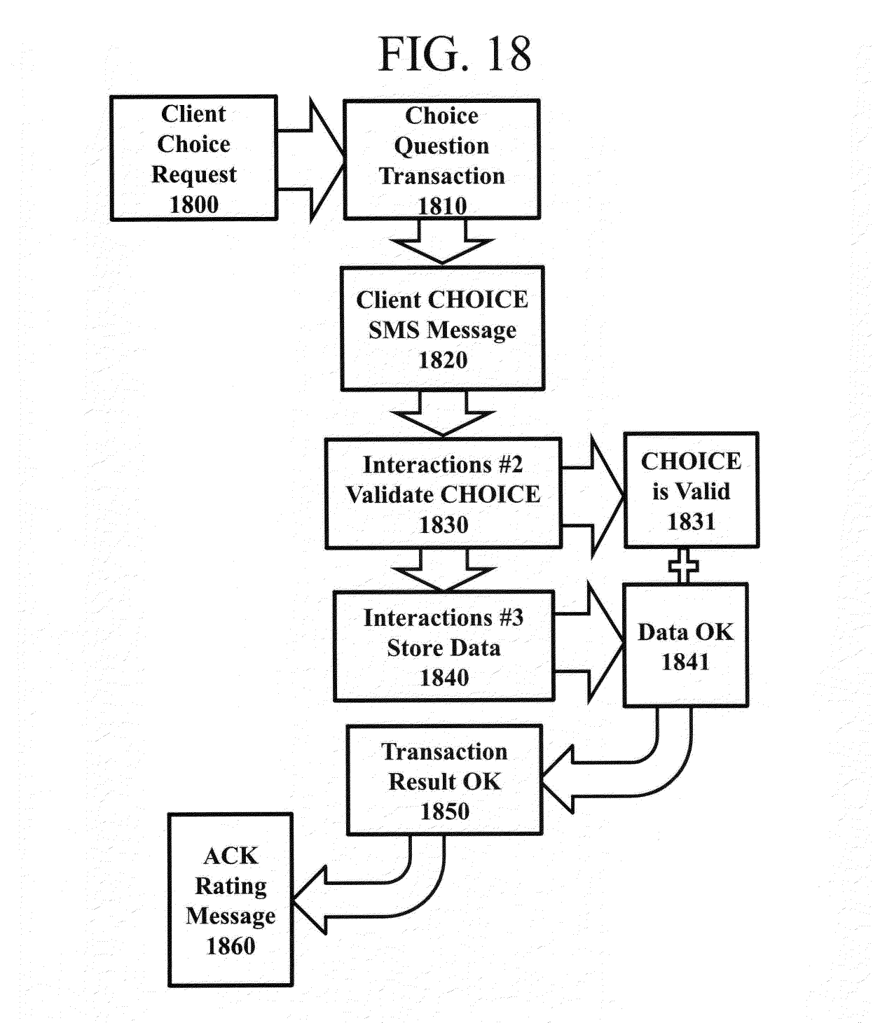

An IENS can also be used to collect information from a specified audience 320. A client can initiate a poll using a communication cycle similar to that illustrated in FIG.15. From the flowchart in FIG. 15, the message 310 generated in step 1540 may contain questions which require a response from an audience 320. The responses are handled using the process illustrated in the flowchart of FIG. 18. The choice of an audience member 321 arrives in step 1800. This arrival creates a transaction in step 1810 to record the responses by audience member 321 in the peer enterprise servers 60. The transaction generates two interactions—one to validate the choice (1830) syntactically and semantically against the options provided to the audience member, and one to store the choice with a peer enterprise server (1840). If the choice entered by the audience member is valid (1831) and the data is properly stored (1841), a transaction result (1850) is generated and a response is provided to the audience member in step 1860.

The communication cycles detailed in FIGS. 15 and 18 may be used to poll employees of an enterprise. For such an implementation, the steps are as follows:

1. System triggered to start a ‘polling’ notification (aka ‘Choice’)

2. Notification message sent to the ‘audience’ (not necessarily specifically employees or customers), with a message that includes a question. Examples of the question are as follows:
a. Will you be reporting to work today? Please respond with ‘YES’ or ‘NO’.
b. What is your location? Respond with 1 for in transit, 2 for at work, 3 for at home.
c. Please indicate your preference for lunch: Respond with ‘BEEF’ or ‘CHICKEN’ or ‘VEGAN’.

3. On response from a member of the ‘audience’, the response is validated, stored, and visualized/aggregated.

The above-described embodiments of the present invention are intended to be examples only.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above, all of which are intended to fall within the scope of the invention as defined in the claims that follow.

Having thus described the invention, what is claimed as new and secured by Letters Patent is:

1. A server for use in an enterprise as a notification server, the server comprising:
a client request gateway module for receiving and validating client requests, said client request gateway also being for mapping validated client requests with transactions;
an enterprise interaction engine module for receiving said transactions from said client request gateway and for producing transactional results, said transactional results being based on results of interactions, said interactions being translated from said transactions, said interactions being processed by external application servers;
a notification engine module for creating notifications for transmittal to an audience, said notifications being based on said transactional results;
wherein
said transactions are for coordinating activities relating to a specific client request;
said interactions are activities related to a specific client request, said activities being for execution by an external application server;
said notifications being at least one message for communication to at least one member of said audience;
said client requests originate as text messages from client devices.

2. A server according to claim 1 wherein said interactions relate to a validation of incoming client requests.

3. A server according to claim 2 wherein said interactions relate to a data retrieval executed by said external application servers.

4. A server according to claim 1 Wherein said interactions relate to storing data, said storing being executed by said external application servers.

5. A server according to claim 1 wherein said interactions relate to an execution of a predetermined set of computer instructions by said external application servers.

6. A server according to claim 1 wherein said interactions relate to a determination of a status of a process on at least one of said external application servers.

7. A server according to claim 1 wherein said audience includes a client device from which an original client request originated.

8. A server according to claim 1 wherein said audience includes members of a management team for a business operating said server.

9. A server according to claim 1 wherein said notification is transmitted to multiple devices for at least one specific member of said audience.

10. A server according to claim 1 wherein said audience is divided into groups such that notifications transmitted to one group are not transmitted to another group.

11. A server according to claim 3 wherein data retrieved by said data retrieval is transmitted to said audience as part of a notification.

12. A server according to claim 11 wherein said audience includes a client device from which an original client request originated.

13. A server according to claim 3 wherein data retrieved by said data retrieval relates to product information.

14. A system according to claim 1 wherein said interactions relate to adding a member to said audience.

15. A server according to claim 14 wherein said member to be added to said audience is a client device from which an original client request originated.

16. A server according to claim 1 wherein said client request relates to issues at a particular location of an enterprise.

17. A server according to claim 1 wherein said client request relates to a rating of an enterprise.

18. A server according to claim 17 wherein said client request relates to a rating of a transaction involving said enterprise.

19. A server according to claim 1 wherein operations of said server are configurable with relation to at least one of:
clients able to send client requests;
transactions created by said client requests;
interactions created by said transactions;
notification created based on interaction results;
members of said audience; and
client devices associated with said members of said audience.

20. A server according to claim 1 wherein said client request relates to conducting a poll with members of said audience.

21. A server according to claim 20 wherein said poll is delivered to said members of said audience and said members are provided with a choice of responses to a polling question.

22. A method for processing incoming communication client requests, the method comprising:
a) receiving an incoming client request, said incoming client request being derived from a text message from a client device;
b) validating said incoming client request;
c) creating at least one transaction associated with said incoming client request;
d) creating at least one interaction relating to said at least one transaction;
e) transmitting said at least one interaction to at least one application server for execution;
f) receiving at least one interaction result from said at least one application server;
g) creating at least one transaction result based on said at least one interaction result;
h) transmitting at least one notification to members of an audience, said at least one notification being based on said at least one transaction result;
wherein
said transactions are for coordinating activities relating to a specific client request;
said interactions are activities related to a specific client request, said activities being for execution by an external application server; and
said notifications being at least one message for communication to at least one member of said audience.

23. A method according to claim 22 wherein said audience includes said client device from which an original text message originated.

24. A method according to claim 22 wherein said client request relates to a request for information;

25. A method according to claim 24 wherein said at least one interaction relates to a retrieval of data from said at least one application server.

26. A method according to claim 25 wherein said notification is sent to an audience including a client device from which an original text message originated, said notification including at least a portion of said data retrieved from said at least one application server.

27. A method according to claim 22 wherein said client request relates to a request for registration to be a member of a specific audience group.

28. A method according to claim 27 wherein said at least one transaction result comprises an acknowledgement that a specific client device has been added as being a member of said specific audience group.

29. A method according to claim 27 wherein said at least one interaction comprises data and instructions for registering a specific client device with a specific audience group using said at least one application server.

30. A method according to claim 27 wherein said specific audience group receives specific notifications relating to an enterprise using a server executing said method.

31. A method according to claim 22 wherein said client device is a mobile computing device.
